(19) United States
(12) Patent Application Publication
(10) Pub. No.: US 2011/0257339 A1
(43) Pub. Date: Oct. 20, 2011

(54) METHOD FOR STABILIZING POLYMERS

(75) Inventors: Frank Fischer, Kirchheim (DE); Ralf Widmaier, Ludwigshafen (DE); Angelika Maschke, Mannheim (DE); Karl Kolter, Limburgerhof (DE); Antonietta Mauri, Albersweiler (DE)

(73) Assignee: BASF SE, Ludwigshafen (DE)

(21) Appl. No.: 13/141,528

(22) PCT Filed: Dec. 17, 2009
(86) PCT No.: PCT/EP2009/067358

§ 371 Date: Jun. 22, 2011

(30) Foreign Application Priority Data
Dec. 22, 2008 (EP) 08172552.5
Dec. 15, 2009 (EP) 09179279.6

(51) Int. Cl. C08F 226/10; C08F 283/06; C08F 26/10

(52) U.S. Cl. 525/185; 526/264

(57) ABSTRACT

Process for the preparation of low-peroxide polymer comprising the treatment of the polymer with elemental metal in the presence of a liquid, polymer obtainable by this process, the use thereof, and also drugs comprising this polymer.

The present invention relates to a process for the preparation of low-peroxide polymer and also low-peroxide polymer stabilized against peroxide formation.

Many oxidation-sensitive polymers such as crosslinked and uncrosslinked homo- and copolymers of N-vinylpyrrolidone are usually converted to pourable powders following their polymerization by spray-drying or drum-drying or another warm-air drying. In these processes, as a result of the intensive air contact and the heat, traces of peroxides are formed, the content of which increases still further in the course of the subsequent packaging, storage and handling. This tendency towards peroxide formation can present problems when using polymers such as polyvinylpyrrolidone (PVP) in pharmaceutical preparations. In the valid pharmacopeia, e.g. Ph. Eur. 6 and JP XIV, the peroxide content for these polymers is limited to a maximum of 400 ppm. Through drying with the exclusion of air, storage at low temperatures or the hermetically sealed packaging under vacuum or an inert gas, the kinetics of peroxide formation can indeed be slowed, but not prevented. In addition, these processes are associated with a very high expenditure, meaning the acceptance of such measures by the user is low.

Comparable problems also arise in the case of the polymer classes of the polyethers, polyalkyleneimines, polyvinylamines, polyvinylformamides and their partially hydrolyzed products, polyimides and polyamides.

Büler writes in his book “Polyvinylpyrrolidone—Excipient for Pharmaceuticals”, Springer, 2005, pages 33 and 34, that all types of povidones (“Povidone” is the generic name for polyvinylpyrrolidone in the pharmaceutical sector) have a measurable growth in the peroxide content upon storage in the presence of atmospheric oxygen. This growth is reportedly particularly severe for the povidone with K value 90. Consequently, it is advisable to store products with these K values at low temperatures and/or hermetically sealed into aluminum-polyethylene double-layered film bags under a nitrogen atmosphere. Nevertheless, according to Bühler, the further increase in peroxide contents can only be slowed, but not stopped, thereby.

Moreover, such aluminum-polyethylene multi-layered film bags are very expensive and the aluminum layer can be easily damaged, as a result of which they largely lose the protective effect against the penetration of oxygen.

Bühler likewise reports on the color change in aqueous solutions of PVP, particularly after storage or heating, for example during sterilization: the resulting yellow to brown-yellow coloration results from the oxidation by means of atmospheric oxygen. According to Bühler, this can be avoided by adding suitable antioxidants. Bühler names cysteine and sodium sulfite as such antioxidants.

However, a disadvantage of adding such antioxidants is that the peroxides originating from the polymerization and also forming directly afterwards consume a larger amount of the antioxidants even upon their addition to the polymer and thus reduce the protection and the storage time period. To compensate, relatively large amounts of antioxidant therefore have to be used.

The oxidation sensitivity of polymers such as PVP, the macroscopically visible and measurable effects of the oxidation and also proposed measures for containing and inhibiting the oxidation has been described in many publications (see for example Bühler in the publication detailed above; Kline in Modern Plastics, 1945, November, from page 157 onwards; Reppe in the monograph to PVP, Verlag Chemie, Weinheim, 1954, page 24; Peniche et al in Journal of Applied Polymer Science vol. 50, pages 485-493, 1993; EP-B 873 130; Römpp-Chemie-Lexikon, 9th edition, Georg Thieme Verlag, Stuttgart, 1992 regarding the use of antioxidants and also limited suitability of phenolic antioxidants on account of a lack of biodegradability; U.S. Pat. No. 6,331,333; U.S. Pat. No. 6,498,231; Encina et al. in the Journal of Polymer Science: Polymer Letters Edition, vol. 18, pages 757 to 760, 1980; Staszewska in “Die Angewandte Markomolekulare Chemie”, 1983, 118, pages 1 to 17).

A process for stabilizing PVP by means of adding hydrazine and derivatives thereof is known from U.S. Pat. No. 2,821,519.

However, hydrazines are toxicologically unacceptable and undesired in polymeric N-vinylpyrrolidones, N-vinylpyrrolidone copolymers and polymers of N-vinylpyrrolidone derivatives.

EP-B 1 083 884 describes a process for stabilizing polyvinylpyrrolidones against peroxide formation, in which aqueous solutions of the polymers are admixed with very small amounts of heavy metal salts or with peroxide-cleaving enzymes. These remain in the product. Suitable heavy metals are manganese, zinc, cobalt and in particular copper.

However, the use of the proposed heavy metals is disadvantageous on account of possible accumulation in the body. Moreover, the use of enzymes is disadvantageous for reasons of cost and stability.

GB 836,831 discloses a process for stabilizing polyvinylpyrrolidones against discolorations, in which solutions of the polymers are treated with sulfur dioxide, sulfurous acid or alkali metal sulfites.

It is known from DE-A 10 2005 005 974 that in the process known from GB 836,831, the peroxide build-up occurs after storage to an even greater extent than in the case of untreated polymers. DE-A 10 2005 005 974 therefore discloses a process in which the polyvinylpyrrolidones are treated firstly with sulfur dioxide, sulfurous acid or alkali metal salts thereof and then with a free-radical scavenger.

However, this process does not lead to the desired effects with all polymers. For example, color and odor are not always satisfactory.

It was an object of the present invention to find an improved process for stabilizing polymers against peroxide formation which produces products which have low to no peroxide contents and the peroxide contents of which do not increase, or increase only slightly, even upon storage in an oxygen-containing environment such as air. This stabilization should be achieved without contaminating the products with substances which are prohibitive even in small amounts especially for pharmaceutical and food applications.

A process for the preparation of low-peroxide polymer comprising the treatment of the polymer with elemental metal in the presence of a liquid has been found.

A polymer obtainable by the process according to the invention with a peroxide content of less than 20 ppm, based on the polymer solids content, the peroxide content being determined two days after treatment by means of iodometry in accordance with Ph.Eur. 6, and the polymer having not more than 5 ppm, based on the polymer solids content, of each precious metal and not more than 1000 ppm, based on the polymer solids content, of each nonprecious metal, has likewise been found.

Polymer obtainable by the process according to the invention, where the polymer comprises not more than 5 ppm, based on the polymer solids content, of each precious metal and not more than 1000 ppm, based on the polymer solids content, of each nonprecious metal, and also having a peroxide content of less than 20 ppm, based on the polymer solids content and the peroxide content being measured two days after treatment, and/or having a peroxide content of not more than 100 ppm, based on the polymer solids content and the peroxide content being determined at a time point within up to three months after the date of manufacture, the peroxide content being determined by means of iodometry in accordance with Ph.Eur. 6, has likewise been found.

The use of polymer prepared according to the invention and/or polymer obtainable by the process according to the invention as auxiliary or active ingredient in the field of cosmetics, pharmaceuticals, animal feed, animal health, technology, crop protection, beverage technology or food technology has likewise been found.

Drugs which comprise polymer prepared according to the invention and/or polymer obtainable by the process according to the invention have likewise been found.

In principle, all oxidizable homopolymers and copolymers can be treated by means of the process according to the invention for the treatment of polymer.

The term “polymer” comprises for example linear, water-solubly branched or water-insolubly branched polymers. The term “water-insolubly branched polymer” also comprises the so-called popcorn polymers, which are referred to as “proliferous polymers” or for example in the case of polyvinylpyrrolidone as PVPP. Within the context of this invention, “branched”, “branching”, “crosslinked”, “crosslinking” are used exchangeably and means polymer which has at least one branching point.

“Polymer” also comprises the copolymers, graft homopolymers or graft copolymers, each of which may be present as linear or solubly crosslinked, in particular water-solubly crosslinked, or insolubly crosslinked, in particular water-insolubly crosslinked, polymers.

“Polymer” may also be present in the form of di- or multi-block polymers. It may likewise be present in star, brush or hyperbranched form or as dendrimer.

Within the context of the present invention, “polymer” also comprises mixtures. Within the context of this invention, “mixtures” are mixtures of two or more polymers. Likewise comprised are mixtures of polymer with further substances.

“Further substances” are, for example, oxidic materials such as oxides which comprise silicon and/or aluminum, such as silicon dioxide, glasses or vermiculite or other polymers which are not polymers within the context of this invention, such as, for example, polyethylene, polypropylene, polycarbonate, polyethylene therephthalate, polystyrene, i.e. polymers which are not oxidation-sensitive or are oxidation-sensitive only to a slight extent.

Thus, for example, it is also possible to mix a polymer already treated according to the invention with further polymer or further polymers and/or further substances. The treatment according to the invention can take place before and/or after mixing. If the treatment takes place before mixing, then one, several or all of the polymers to be mixed can be treated. The resulting mixture can then be treated again.

If, for example, water-insolubly crosslinked polyvinylpyrrolidone (PVPP) is mixed with polyamide (PA) or PVPP is mixed with polystyrene (PS), then PVPP and/or PA can be treated individually by itself prior to the mixing and/or the mixture of PVPP/PA or PVPP/PS can be subjected to a joint treatment.

The treatment of the mixture is preferred over the mixing of already treated polymers because the latter procedure leads, on account of customary evolution of heat during the preparation of the mixture, only to identical results if particular value is placed on the avoidance or the minimization of oxygen entry and/or thermal stress especially during the mixing step.

Polymers suitable for the process according to the invention for the treatment of polymers are, for example, vinyllactam polymers, polyethers, polyalkyleneimines, polyvinylamines, polyvinylformamide and partially hydrolyzed products thereof, polyimides and polyamides.

Suitable polymers preferably comprise one or more monomers a), optionally one or more monomers b), and optionally one or more crosslinking monomers c), i.e. they have been obtained by polymerization of said monomers and can also comprise residual amounts of the monomers.

Suitable monomers a) are, for example:

N-vinyllactams, such as N-vinylpyrrolidone, N-vinylpiperidone, N-yl nylcaprolactam, derivatives thereof substituted with C1- to C8-alkyl groups, such as 3-methyl-, 4-methyl- or 5-methyl-N-vinylpyrrolidone.

N-Vinylamides, such as N-vinylformamide and the N-vinylamine thereof obtainable following polymerization by hydrolysis, N-vinyl-N-methylacetamide.

Amines, such as N-vinyl- or allyl-substituted heterocyclic compounds, preferably N-vinylpyridine, or N-allylpyridine, N-vinylimidazoles, which may also be substituted in the 2-, 4- or 5-position with C1-C4-alkyl, in particular methyl or phenyl radicals, such as 1-vinylimidazole, 1-vinyl-2-methylvinylimidazole, and quaternized analogs thereof, such as 3-methyl-1-vinylimidazolium chloride, 3-methyl-1-vinylimidazolium methylsulfate, N—C1- to C24-alkyl-substituted diallylamines or quaternized analogs thereof, such as diallylammonium chloride or diallyldimethylammonium chloride.

Polymers according to the invention may be homopolymers and also copolymers of two or more of the monomers a), for example copolymers of N-vinylpyrrolidone and N-vinylimidazole, copolymers of N-vinylpyrrolidone and N-vinylformamide or copolymers of N-vinylpyrrolidone and N-vinylcaprolactam.

Preferred monomers a) are vinyllactams such as N-vinylpyrrolidone, 3-methyl-N-vinylpyrrolidone, 4-methyl-N-vinylpyrrolidone, 5-methyl-N-vinylpyrrolidone, N-vinylpiperidone and N-vinylcaprolactam, vinyl acetate, and also the vinyl alcohol obtainable by hydrolysis after the polymerization, vinylamides such as vinylformamide, and also the vinylamine obtainable by hydrolysis after the polymerization, N-vinylimidazole, 1-vinyl-3-methylimidazolium chloride, 1-vinyl-3-methylimidazolium sulfate, and vinylmethylacetamide, and derivatives thereof.

Very particularly preferred monomers a) are N-vinylpyrrolidone, N-vinylcaprolactam, vinyl acetate, vinylformamide, and also the vinylamine obtainable by hydrolysis after the polymerization or N-vinylimidazole.

Suitable Monomers b) are:

acrylic acids and derivatives thereof, such as substituted acrylic acids, and also salts, esters and amides thereof, where the substituents are on the carbon atoms in the 2- or 3-position of the acrylic acid and are selected independently of one another from the group consisting of C1-C4-alkyl, —CN and —COORS.

These include, for example:

acrylic acids such as acrylic acid itself or anhydride thereof, methacrylic acid, ethylacrylic acid, 3-cyanoacrylic acid, maleic acid, fumaric acid, crotonic acid, maleic anhydride or half-ester thereof, itaconic acid or half-ester thereof;
acrylamides such as acrylamide itself, N-methylacrylamide, N,N-dimethylacrylamide, N-ethylacrylamide, N-1-propylacrylamide, N-2-propylacrylamide, N-butylacrylamide, N-2-butylacrylamide, N-t-butylacrylamide, N-octylacrylamide, N-t-octylacrylamide, N-octadecylacrylamide, N-phenylacrylamide, N-dodecylacrylamide, laurylacrylamide, stearylacrylamide, N-2-hydroxyethylacrylamide, N-3-hydroxypropylacrylamide, N-2-hydroxypropylacrylamide; methacrylamides such as methacrylamide itself, N-methylmethacrylamide, N,N-dimethylmethacrylamide, N-ethylmethacrylamide, N-1-propylmethacrylamide, N-2-propylmethacrylamide, N-butylmethacrylamide, N-2-butylmethacrylamide, N-t-butylmethacrylamide, N-octylmethacrylamide, N-t-octylmethacrylamide, N-octadecylmethacrylamide, N-phenylmethacrylamide, N-dodecylmethacrylamide, N-laurylmethacrylamide, stearyl(meth)acrylamide, N-2-hydroxyethyl(meth)acrylamide, N-3-hydroxypropyl(meth)acrylamide, N-2-hydroxypropyl(meth)acrylamide;
further amides such as ethacrylamide, maleimide, fumaric acid monoamide, fumaric diimide;
aminoalkyl(meth)acrylamides such as (dimethylamino)methyl(meth)acrylamide, 2-(dimethylamino)ethyl(meth)acrylamide, 2-(dimethylamino)propyl(meth)acrylamide, 2-(diethylamino)propyl(meth)acrylamide, 3-(dimethylamino)propyl(meth)acrylamide, 3-(diethylamino)propyl(meth)acrylamide, 3-(dimethylamino)butyl(meth)acrylamide, 4-(dimethylamino)butyl(meth)acrylamide, 8-(dimethylamino)octyl(meth)acrylamide, 12-(dimethylamino)dodecyl(meth)acrylamide, or analogs thereof quaternized on the amine with, for example, methyl chloride, ethyl chloride, dimethyl sulfate or diethyl sulfate, such as, for example, 3-(trimethylammonium)propyl(meth)acrylamide chloride;

acrylates such as C1-C18-alkyl acrylates such as methyl acrylate, ethyl acrylate, n-propyl acrylate, isopropyl acrylate, n-butyl acrylate, isobutyl acrylate, t-butyl acrylate, 2-ethylhexyl acrylate, decyl acrylate, dodecyl acrylate, lauryl acrylate, stearyl acrylate, 2,3-dihydroxypropyl acrylate, 2-hydroxyethyl acrylate, 2-hydroxypropyl acrylate, 3-hydroxypropyl acrylate, 2,3-dihydroxypropyl acrylate, 2-methoxyethyl acrylate, 2-methoxypropyl acrylate, 3-methoxypropyl acrylate, 2-ethoxyethyl acrylate, 2-ethoxypropyl acrylate, 3-ethoxypropyl acrylate, glyceryl monoacrylate, alkylene glycol acrylates or polyalkylene glycol acrylates having in total 2 to 200 EO and/or PO units and/or EO/PO units with hydroxy, amino, carboxylic acid, sulfonic acid or alkoxy group such as methoxy or ethoxy groups on the end of the chain, where “EO” means “ethylene oxide” and “PO” means propylene oxide;

methacrylates such as C1-C18-alkyl methacrylates, such as methyl methacrylate, ethyl methacrylate, n-propyl methacrylate, isopropyl methacrylate, n-butyl methacrylate, isobutyl methacrylate, t-butyl methacrylate, 2-ethylhexyl methacrylate, decyl methacrylate, dodecyl methacrylate, stearyl methacrylate, 2,3-dihydroxypropyl methacrylate, 2-hydroxyethyl methacrylate, 2-hydroxypropyl methacrylate, 3-hydroxypropyl methacrylate, 2,3-dihydroxypropyl methacrylate, 2-methoxyethyl methacrylate, 2-methoxypropyl methacrylate, 3-methoxypropyl methacrylate, 2-ethoxyethyl methacrylate, 2-ethoxypropyl methacrylate, 3-ethoxypropyl methacrylate, glyceryl monomethacrylate, and also alkylene glycol methacrylates or polyalkylene glycol methacrylates having in total 2 to 200 EO and/or PO units and/or EO/PO units with hydroxy, amino, carboxylic acid, sulfonic acid or alkoxy group such as methoxy or ethoxy groups on the end of the chain;
ethacrylates such as C1-C18-alkyl ethacrylates, such as methyl ethacrylate, ethyl ethacrylate, n-butyl ethacrylate, isobutyl ethacrylate, t-butyl ethacrylate, 2-ethylhexyl ethacrylate, decyl ethacrylate, 2-hydroxyethyl ethacrylate, 2-methoxyethyl acrylate, 2-methoxyethyl ethacrylate, 2-ethoxyethyl ethacrylate;
amino-C1-C18-alkyl (meth)acrylates such as N,N-dimethylaminomethyl (meth)acrylate, N,N-diethylaminomethyl (meth)acrylate, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminobutyl (meth)acrylate, N,N-diethylaminobutyl (meth)acrylate, N,N-dimethylaminohexyl (meth)acrylate, N,N-dimethylaminooctyl (meth)acrylate, N,N-dimethylaminododecyl (meth)acrylate or analogs thereof quaternized on the amine with for example methyl chloride, ethyl chloride, dimethyl sulfate or diethyl sulfate;
alkyl esters such as uniform or mixed diesters of maleic acid with methanol, ethanol, 1-propanol, 2-propanol, n-butanol, 2-butanol, tert-butanol, alkylene glycol or polyalkylene glycol having in total 2 to 200 EO and/or PO units and/or EO/PO units with hydroxy, amino, carboxylic acid, sulfonic acid or alkoxy group such as methoxy or ethoxy groups on the end of the chain;
alkyl esters of C1-C40 linear, C3-C40 branched-chain or C3-C40 carbocyclic carboxylic acids;
vinyl ethers, such as methyl, ethyl, butyl or dodecyl vinylethers;
ethers of allyl alcohol and polyethylene oxide and/or propylene oxide and/or poly(ethylene oxide-co-propylene oxide) having in total 2 to 200 EO and/or PO units and/or EO/PO units with hydroxy, amino, carboxylic acid, sulfonic acid or alkoxy groups such as methoxy or ethoxy groups on the end of the chain; vinyl esters such as vinyl esters of aliphatic C1-C18-carboxylic acids, such as vinyl formate, vinyl acetate and vinyl alcohol thereof obtainable after the polymerization by hydrolysis, vinyl propionate, vinyl butyrate, vinyl laurate, vinyl stearate, vinyl neodecanoate VEOVA 9 (CAS 54423-67-5) or VEOVA 10 (CAS 51000-52-3); N-vinyloxazolines such as N-vinyloxazoline, N-vinylmethyloxazoline, N-vinylethyloxazoline, N-vinylpropyloxazoline, N-vinylbutyloxazoline, N-vinylphenyloxazoline;
halides such as vinyl halides or allyl halides, such as vinyl chloride, allyl chloride, vinylidene chloride;
olefinically unsaturated hydrocarbons such as hydrocarbons having at least one carbon-carbon double bond, such as styrene, alpha-methylstyrene, tert-butylstyrene, butadiene, isoprene, cyclohexadiene, ethylene, propylene, 1-butene, 2-butene, isobutene, vinyltoluene;
sulfonic acids such as unsaturated sulfonic acids, such as, for example, acrylamidopropanesulfonic acid, styrene sulfonate;
methyl vinyl ketone, vinylfuran, allyl alcohol.

Preferred monomers b) are maleic acid, maleic anhydride, isopropylmethacrylamide, acrylamide, methacrylamide, 2-hydroxyethylacrylamide and 2-hydroxy-ethylmethacrylamide, also vinyl esters of aliphatic C2-C18-carboxylic acids, such as vinyl acetate, and also the vinyl alcohol obtainable by hydrolysis after the polymerization, vinyl propionate, vinyl butyrate, vinyl laurate, vinyl stearate, vinyl neodecanoate VEOVA 9 and VEOVA 10, also dimethylaminoethyl (meth)acrylate and dimethylaminoethyl(meth)acrylamide or quaternized analogs thereof, and also diallyldimethylammonium chloride.

Very particularly preferred monomers b) are methacrylamide, vinyl acetate, and also the vinyl alcohol obtainable by hydrolysis after the polymerization, vinyl propionate, vinyl neodecanoate VEOVA 9 and VEOVA 10, dimethylaminoethyl (meth)acrylate or dimethylaminoethyl(meth)acrylamide or quaternized analogs thereof, and also diallyldimethylammonium chloride.

Polymers which are copolymers and comprise monomers b) can comprise one or more of the monomers b). Usually, however, not more than five different monomers b) are present in one copolymer.

Preferred polymers further include copolymers which comprise one or more monomers a) and one or more monomers b).

Suitable crosslinking monomers c) (“crosslinkers”) are:

crosslinking monomer c) are described for example in WO2009/024457 on page 7, line 1 to page 9, line 2, to which reference is hereby expressly made.

Particularly preferred crosslinking monomers c) are pentaerythritol triallyl ether, methylenebisacrylamide, N,N′-divinylethylene urea, divinylbenzene, ethylene bis-N-vinylpyrrolidone, 3-vinyl-N-vinylpyrrolidone, 4-vinyl-N-vinylpyrrolidone, 5-vinyl-N-vinylpyrrolidone, allyl (meth)acrylate, triallylamine and acrylic acid esters of glycol, butanediol, trimethylolpropane or glycerol, and also acrylic acid esters of glycol, butanediol, trimethylolpropane or glycerol reacted with ethylene oxide and/or epichlorohydrin.

Crosslinking monomers c) particularly preferred for the use for the so-called popcorn polymerization are N,N′-divinylethylene urea, ethylene bis-N-vinylpyrrolidone, 3-vinyl-N-vinylpyrrolidone, 4-vinyl-N-vinylpyrrolidone, 5-vinyl-N-vinylpyrrolidone, of which very particular preference is given to N,N′-divinylethylene urea.

The quantitative fractions in percent by weight based on the total mass of the polymer are here for the monomers a) usually at least 20, preferably at least 30, particularly preferably at least 50, especially preferably at least 60 percent by weight and very especially preferably up to 100 percent by weight, such as, for example, homopolymers of 100% of a monomer a).

The quantitative fractions in percent by weight based on the total mass of the polymer are here for the monomers b) usually up to 80, preferably up to 70, particularly preferably up to 50, especially preferably up to 40 and very especially preferably less than 5 percent by weight and are, for example, not present at all in the polymer.

If the polymer is water-solubly crosslinked polymer, the quantitative fractions of the crosslinking monomers c) in percent by weight based on the total mass of the polymer are usually 0.001 to 20, preferably 0.01 to 10, particularly preferably 0.05 to 5 and especially 0.1 to 1 percent by weight.

If the polymer is water-insolubly crosslinked polymer such as, for example, a popcorn polymer, the quantitative fractions of the crosslinking monomers c) in percent by weight based on the total mass of the polymer are usually 0.001 to 10, preferably 0.01 to 5, particularly preferably 0.1 to 3 and especially 0.5 to 2 percent by weight.

If a crosslinking monomer c) is used, then the quantitative fractions of monomer a) and/or monomer b) are reduced accordingly by the amount of crosslinking monomer c) used.

The total amounts of monomer a), monomer b) and monomers c) always add up here to 100 percent by weight.

Thus, for example, a typical polyvinylpyrrolidone popcorn polymer comprises only vinylpyrrolidone as monomer a) in the quantitative fraction from 95 to 99.8 percent by weight, preferably 97.5 to 99 percent by weight, and a crosslinking monomer c) in the quantitative fraction from 0.2 to 5 percent by weight, preferably 1 to 2.5 percent by weight, for example 98.1 percent by weight of monomer a) and 1.9 percent by weight of monomer c).

The monomers a), b) and c) used for the polymerization may, independently of one another, be an individual or mixtures of two or more monomers a), monomers b) and/or monomers c), where the combined quantitative fraction of the monomers a), b) or c) gives the quantitative fraction specified in each case for monomer a), for monomer b) or for monomer c), respectively, in the polymer.

A vinyllactam polymer may be a homopolymer or copolymer comprising N-vinyllactams, such as N-vinylpyrrolidone (VP) or derivatives thereof methyl-substituted in the 3-, 4- or 5-position, N-vinylpiperidone or N-vinylcaprolactam (VCap). Preference is given to N-vinylpyrrolidone, N-vinylcaprolactam or mixture thereof. Particular preference is given to N-vinylpyrrolidone.

Preferred vinyllactam polymers are vinylpyrrolidone polymers, such as polyvinylpyrrolidones, vinylpyrrolidone copolymers and vinylpyrrolidone popcorn polymers.

Preferred polyvinylpyrrolidones are polymers with K values of from 1 to 150, preferably K10 to K120, for example K12, K15, K 17, K25, K30, K60, K85, K90, K95, K100, K115 or K120. Particularly preferred PVP homopolymers have a K value of from 12 to 95 and particularly preferably from 15 to 40.

Preferred vinylpyrrolidone copolymers are linear, uncrosslinked copolymers with N-vinylcaprolactam (VCap), vinyl acetate (VAc), N-vinylimidazole (VI) or derivatives thereof or mixtures thereof.

Very particularly preferred copolymers are copolymers of N-vinylpyrrolidone (VP) with vinyl acetate having a VPNAc weight ratio of from 20:80 to 80:20, for example 30:70, 50:50, 60:40, 70:30, with K values of from 10 to 150, preferably from 15 to 80 and in particular from 20 to 50. Particularly preferred copolymers of N-vinylpyrrolidone with vinyl acetate have a K value of from 25 to 50 and a weight ratio of VP to VAc of from 55:45 to 70:30.

Preference is likewise given to copolymers of VP and VI and also copolymers of VP and VCap, in each case having K values of from 10 to 100, preferably from 12 to 80 and in particular from 20 to 75, and also weight ratios of the monomers VP to VI or VP to VCap of from 80:20 to 20:80, preferably from 70:30 to 30:70, especially preferably from 60:40 to 40:60 and for example also 50:50.

The K value is determined here in accordance with Fikentscher (see Bühler, page 40 and 41).

Preference is also given to copolymers of VP and 1-vinyl-3-methylimidazolium chloride or 1-vinyl-3-methylimidazolium sulfate (“QVI”; obtained by quaternization of 1-vinyl-imidazole with methyl chloride or dimethyl sulfate) having a weight ratio of VP/QVI of from 20:80 to 99:1, where the copolymers can have molecular weights Mw of from 10 000 to greater than 1 000 000 daltons (determined by means of GPC).

The preparation of N-vinyllactam polymers by free-radical polymerization is known per se. The free-radical polymerization can also take place in the presence of customary crosslinkers and in this case produces branched or crosslinked polymers which are water-soluble to gel-forming in water depending on the degree of crosslinking.

The preparation of water-soluble polyvinylpyrrolidones can take place for example as solution polymerization in a suitable solvent such as water, mixtures of water and organic solvents, for example ethanol/water or isopropanol/water mixtures or in purely organic solvents such as methanol, ethanol or isopropanol. These preparation methods are known to the person skilled in the art.

Preferred water-insolubly crosslinked polymers are polymers of vinylpyrrolidone or of vinylpyrrolidone with vinylimidazole, vinylcaprolactam and/or vinyl acetate which have been prepared by means of the so-called “popcorn” polymerization (also referred to as “PVPP” or “Crospovidone”, also as “proliferous polymer”; polymerization and polymers are described for example in Breitenbach et al. IUPAC International Symposium on macromolecular Chemistry, Budapest 1969 (pp. 529-544) or Haaf, Sanner, Straub, Polymer Journal vol. 17, No. 1 pp 143-152 (1985)).

The crosslinkers used for the preparation of popcorn polymers are formed in situ by a reaction step prior to the actual polymerization reaction or are added as defined compound.

The preparation of polyvinylpyrrolidone popcorn polymers contemplated according to the invention with the addition of crosslinkers is described for example also in EP-A 88964, EP-A 438 713 or WO 2001/068727.

The preparation of popcorn polymers such as polyvinylpyrrolidone by generating crosslinkers in situ in a step prior to the actual popcorn polymerization and their polymerization with the specified monomers to give crosslinked, water-insoluble popcorn polymers is known for example also from U.S. Pat. No. 3,277,066 or U.S. Pat. No. 5,286,826. Preferred popcorn polymers are obtained using divinylethyleneurea as crosslinking monomers c) and also as monomers a) N-vinylpyrrolidone and N-vinylimidazole and/or N-vinylcaprolactam, and optionally N-vinyl acetate as monomer b).

Preferred popcorn polymers are also obtained from in situ prepared crosslinkers and also N-vinylpyrrolidone, N-vinylimidazole, N-vinylcaprolactam and/or N-vinylacetate.

Particularly preferred popcorn polymers are obtained from N,N′-divinylethyleneurea and N-vinylpyrrolidone or from N,N′-divinylethyleneurea and N-vinylpyrrolidone and N-vinylimidazole.

Such popcorn polymers are also commercially available, for example as Kollidon® CL, Kollidon® CL-F or Kollidon® CL-SF from BASF SE, or as Polyplasdone® XL, Polyplasdone® XL-10, Polyplasdone® INF-10, Polyplasdone® Ultra or Polyplasdone® Ultra-10 from ISP Corp., USA.

Popcorn polymers which comprise N-vinylpyrrolidone and N-vinylimidazole in the weight ratio 1:9 are also commercially available for example as Divergan® HM from BASF SE.

Polyvinylamides are in particular the homopolymers and copolymers of vinylformamide, N-vinylmethylacetamide or N-isopropylacetamide. Vinylformamide may here have been completely or partially hydrolyzed to vinylamine after the polymerization.

Polyethers may be polyethylene glycols (PEG) with average molecular weights Mw of from 200 to 50 000 daltons or the polyethylene oxides with average molecular weights Mw of from 40 000 to 10 000 000 daltons (determined by means of GPC). Furthermore, polyethers of the form aba may be as block copolymers of ethylene oxide and propylene oxide (for example the types known as poloxamers) or their inverse forms (for example the types known as meroxapols) of the structure bab, where a is a polyoxyethylene structure with an average molecular weight of from 150 daltons to 10 000 daltons and b is a polyoxypropylene structure with an average molecular weight of from 700 daltons to 7000 daltons. In addition, polyethers may also be poloxamines. Poloxamines are structurally composed of an ethylenediamine core, the amino groups of which are substituted with copolymers of polyoxyethylene and polyoxypropylene blocks of variable length:

[H—(C2H4O)a-(C3H6O)b]2N—CH2-H2-N[(C3H6O)b-(C2H4O)a-H]2

where a and b are variable and can comprise average molecular weights as stated above. Polyethers may also be reaction products which are obtained by base-catalyzed reaction of ethylene oxide with fatty alcohols, fatty acids or animal or vegetable oils and fats. These substances are commercially available, for example, as Cremophor® or Solutol® brands. In addition, polyethers may be compounds of polyoxyethylene esters of long-chain carboxylic acids, such as from the product group Tween® (polyoxyethylene sorbitan ester of long-chain carboxylic acids) such as Tween® 20 (polyoxyethylene (20) sorbitan monolaurate) to Tween® 85 (polyoxyethylene sorbitan trioleate) or from the product groups Span®, Brij® or Mrij®.

Also comprised are polyether-containing copolymers which have been polymerized from polymerizable polyether-containing monomers (also often referred to as “macromonomers”) and other monomers. Examples of polyether-containing monomers are supplied as Bisomer® grades (polyether acrylates or methacrylates) and as Pluriol® A grades (polyether allyl alcohols and derivatives).

Polyethers likewise comprise polyether-containing graft polymers of polyethers and vinyl monomers such as vinyl acetate (VAc) and—after its polymerization—its hydrolysis product vinyl alcohol (VOH), vinyllactams such as N-vinylpyrrolidone (NVP) and/or N-vinylcaprolactam (VCap), vinylamines, such as N-vinylimidazole (VI), N-vinylformamide (VFA) and—after the polymerization—its hydrolysis product vinylamine.

Such graft polymers of for example polyethylene glycol and vinyl acetate, after the polymerization largely hydrolyzed to vinyl alcohol, are known for example as Kollicoat® IR. Graft polymers of polyethylene glycol and vinylpyrrolidone with vinylimidazole and also of polyethylene glycol and vinylcaprolactam with vinyl acetate are likewise known.

Preferred polyethers are in particular polytetrahydrofuran, graft polymers of PEG with vinyl acetate completely or largely hydrolyzed to vinyl alcohol, graft polymers of PEG with NVP and VAc, graft polymers of PEG with VCap and VAc, graft polymers of PEG with NVP and VI, graft polymers of PEG with VCap and VI, polyethylene glycols such as Lutrol®, Pluriol® and Macrogol grades, the polyoxyalkylene amines marketed under the trade name Jeffamine®, poloxamers, Cremophors® such as in particular Cremophor® RH40 (a hydrogenated caster oil alkoxylated with 40 EO units) or Cremophor® EL (a caster oil alkoxylated with 35 EO units), and Solutols®, in particular Solutol® HS 15 (a macrogol-15-hydroxystearate).

Very particularly preferred polyethers are graft polymers of PEG with vinyl acetate completely or largely hydrolyzed to vinyl alcohol, and also graft polymers of PEG with VCap and VAc.

PEG is present here in the last-mentioned polyethers in general in quantitative fractions of from 5 to 90 percent by weight, VCap in 10 to 70 percent by weight and VAc in quantitative fractions of from 5 to 50 percent by weight. The total fractions here are selected such that they give 100%.

Polyamides comprise homopolymers and copolymers which can be prepared by condensation reactions from alkyl- and aryl-containing diamines and diacids, from alkyl- and aryl-containing amino carboxylic acids or from lactams, for example polyamide 6,6.

The preparation of the polyether graft polymers, of the polyvinylamides and of the polyamides is known to the person skilled in the art. It can take place for example in aqueous or organic solution, in emulsion, suspension or in bulk or as precipitation polymerization. The additives optionally required for the polymerization, such as surfactants, emulsifiers or solubility promoters, and also suitable process conditions are known to the person skilled in the art.

Thus, the polyvinylamides can be prepared for example by free-radical polymerization, for example in solution. After the polymerization, polyvinylformamide can be partially or completely hydrolyzed, for example under acidic conditions, for example with sulfuric acid, to give polyvinylamine. Popcorn polymers of vinylformamide and its hydrolysis product vinylamine can also be prepared.

Polyethers can be obtained for example by addition reaction of ethylene oxide and/or propylene oxide.

Polyamides are accessible for example by condensation starting from diacids with diamides, from amino acids or from lactams.

Graft polymers can be obtained for example by free-radical polymerization of monomers in the presence of polymers which then serve as graft base for the monomers. Such reactions can be prepared in two or more steps or else stepwise in one reaction container.

The process according to the invention for the preparation of low-peroxide polymers by treating the polymer with metal takes place in the presence of a liquid.

Within the context of this invention, “liquid” is understood as meaning all substances which have a melting point of less than 100° C. and are therefore present in liquid form at least in a part-range of the temperature range from 0 to 100° C. at atmospheric pressure, or which become liquid at least in such a part-range as a result of increasing the pressure to above atmospheric pressure.

Within the context of this invention, liquids are therefore organic and inorganic substances, such as organic solvents, inorganic and organic salts, and also gases. As liquid, a mixture of two or more different liquids can likewise be used.

Liquid can be understood as meaning one which is inert or essentially inert toward the polymer subjected in each case to the process according to the invention.

The liquid may be solvent or dispersant for the polymer.

Typical representatives of the organic solvents are, for example, C1- to C8-alcohols, such as methanol, ethanol, N-propanol, isopropanol, butanol, glycol, glycerol, diethyl ether. Preference is given to using methanol, ethanol and/or isopropanol.

Typical representatives of salts are the salts liquid under treatment conditions, so-called “ionic liquids”, for example based on imidazole.

Typical representatives of the gases are, for example, carbon dioxide, dimethyl ether, ethane, propane or butane.

Organic solvents, water or mixtures thereof are preferably used. Very particular preference is given to using predominantly water.

Water may be water of varying quality: water of technical-grade quality, water of naturally occurring quality such as surface water, river water or ground water, and also purified water. Purified (“pure”) water can be purified by purification methods such as single or multiple distillation, demineralization, diffusion, adsorption, by means of ion exchangers and also activated carbons or other absorbents, by means of a filtration method such as ultrafiltration or dialysis. “Pure” water is usually used here to refer to singularly or multiply distilled water and also completely demineralized water.

In a further embodiment, carbon dioxide is the preferred liquid. It is a particular advantage of carbon dioxide that it can be removed easily following treatment by reducing the pressure, whereupon the gas automatically vaporizes such that the low-peroxide polymer remains in solid form.

The treatment according to the invention usually takes place in the case of the soluble polymers in solution, in the case of water-soluble polymers preferably in aqueous solution. In the case of the insoluble polymers, such as the polyvinylpyrrolidone popcorn polymers, the treatment takes place in a dispersion. “Dispersion” comprises here suspensions and slurries. Preferably, in the case of the insoluble polymers, their treatment is in aqueous dispersion.

The polymer solutions or dispersions to be treated usually have a solids content of from 5 to 80% by weight, preferably 5 to 50% by weight. In the case of dispersions, the solids content is particularly preferably 5 to 25% by weight and in particular 8 to 15% by weight. It is possible to use those solutions or dispersions as are obtained directly from the preparation of the polymers, such as, for example, in the solvent of the polymerization or the post-polymerization. However, it is also possible to dissolve or to disperse solid polymers and then to treat these according to the invention.

The treatment according to the invention particularly preferably takes place in aqueous solutions or in aqueous dispersions.

The process according to the invention for the treatment of polymer generally takes place after the polymerization. The polymerization can, but does not have to, comprise a post-polymerization.

The treatment preferably takes place after the polymerization and particularly preferably after the post-polymerization if one is intended. If drying is intended, the treatment of the polymers preferably takes place before drying. However, a treatment of the afresh dissolved or dispersed polymers is also possible.

In the case of a polymerization in an organic solvent, it may also be advisable to firstly exchange the organic solvent at least partially or completely for water and then to carry out the treatment.

The treatment generally takes place with thorough mixing, preferably stirring. However, the thorough mixing can also take place by introducing a gas such as nitrogen, carbon dioxide, air or by hydrogen or by circulating the mixture by pumping and/or fluidization, for example through the targeted use of static mixers or baffles.

Preferably, the thorough mixing is by means of stirring, circulation by pumping and/or gas introduction. Very particular preference is given to stirring.

According to the invention, the polymer is treated in the presence of a liquid with elemental metal.

In one embodiment, the elemental metal can be here in contact with the polymer and immersed completely or partly into the liquid. “In contact” means that the polymer has direct surface contact with the metal, i.e. for example can at least partially wet the metal.

In a further embodiment, hydrogen is passed into the liquid comprising the polymer and at the same time brought into contact with the metal and the polymer.

In a further embodiment, hydrogen is firstly brought into contact with the metal and then with the polymer.

In this specification, “metal” is understood as meaning the pure metal as such, an alloy which comprises the metal, or a mixture which comprises the metal, unless clearly indicated otherwise from the context.

The metal is preferably used as powder or solid bodies.

Powders usually have average particle diameters less than 100 μm. “Solid bodies”, which comprise the metal or consist of it, can be in the form of granules, grains or some type of shaped material.

The granules here preferably have an average particle size of from 100 μm to 5 mm.

Grains are usually larger particles having average particle sizes above 5 mm in diameter, for instance. Both usually have particles of irregular shape.

Within the context of this invention, “shaped material” has a three-dimensional structure with at least partially regular geometric features such as cylindrical pellets, spheres, wire-like mesh, or material having a sponge-like or other hollow structure. The shaped material can consist of the metal, comprise the metal on the surface or comprise the metal embedded in a matrix. Preferably, the metal on the surface is in contact with the surrounding phase. The surface may here also be located in the inside of a porous shaped material.

Thus, for example, metal can also be applied as coating to a body made of another material and be used like this. For example, a metal, steel or stainless steel body can be coated completely or partially with a preferably thin layer of metal. Here, the layer is “thin” as far as is technically possible, but has at least one atomic layer. Thus, large areas of metal surface can be prepared with a minimum amount of precious metal. This is particularly advantageous when using precious metal.

There are suitable metal-comprising mixtures for example with oxidic substances. Oxidic substances are, for example, silicon oxides, aluminum oxides, mixtures thereof and derivatives thereof or naturally occurring oxidic substances such as, for example, vermiculite.

Metal here may be nonprecious or precious metal. Within the context of this disclosure, metal is “precious” if, during the treatment upon contact with the liquid and in particular upon contact with water, it forms no elemental hydrogen, and “nonprecious” if it reacts to form elemental hydrogen and the metal ion which dissolves.

Of suitability for the treatment with nonprecious metal are, for example, zinc, alkali metals or alkaline earth metals, and also alloys thereof or mixtures thereof. Alloys are, for example, sodium-potassium, sodium-calcium, magnesium-calcium or calcium-zinc. The metal used is preferably zinc, sodium, potassium, magnesium and/or calcium. Particular preference is given to calcium and/or magnesium. Here, calcium is very particularly preferred. The addition of hydrogen here is not necessary, but possible. Preferably, no hydrogen is added.

Bringing the nonprecious metal into contact with polymer takes place for example in portions as one addition or in two or more portions. For safety reasons, however, it can also take place continuously, for example in order to be able to better control an evolution of hydrogen. The addition can take place here as powder or solid bodies, for example as dispersion, in a suitable inert medium. A continuous or portionwise addition is possible for example by means of a rotary valve.

If the treatment according to the invention takes place using nonprecious metals, then it is advisable to use a liquid which comprises at least an adequate amount of a liquid which can form hydrogen with the nonprecious metal, such as for example water, in order to ensure as much of the added nonprecious metal reacts as possible to metal ions which dissolve.

Preferably, nonprecious metal is added directly to the liquid so that it can move freely within this liquid.

If nonprecious metal is used, this is preferably used as pure metal or alloy in the form of powder or fine granules. Here, the polymer is not contaminated with other substances, has a large surface area and is nevertheless not too reactive to still ensure safe handling.

In an alternative embodiment, the treatment according to the invention can also take place with precious metal. Suitable metals are, for example, platinum, palladium, rhodium, iridium, ruthenium, nickel and gold, alloys thereof or mixtures thereof. The metals preferably used are platinum, palladium and/or alloys which comprise at least one of these metals. Platinum and/or alloys thereof are particularly preferred here.

If a precious metal is used, then preferably the pure metal or an alloy thereof are shaped in some form.

Preference is given to using precious metal in pure form or as alloy as shaped material. Preferably, such a shaped material has a very large surface readily accessible for hydrogen gas.

Preferred shaped materials are those having a mesh-like or sponge-like structure such as porous blocks whose insides allow the passage of fluids.

Also particularly preferrable is shaped material that exhibits the largest possible external and/or internal surface area while minimizing the amount of precious metal needed.

Particular preference is given to shaped material whose surfaces that are accessible to gaseous hydrogen are completely or partially coated with the precious metal.

For example, a metal, steel or stainless steel body can be coated with a thin layer of platinum. Thus, large areas of precious-metal surface can be prepared with a minimum amount of precious metal.

Bringing the polymer into contact with the precious metal generally takes place here in containers or tubes. The metal can be placed in these containers or tubes, be attached removable or firmly within these containers or tubes or be part of the containers or tubes.

Preferably, precious metal is placed as shaped material in the liquid such that it cannot freely move therein.

If precious metal is used for the treatment according to the invention of the polymers, then hydrogen is present. Preferably, hydrogen is introduced. Hydrogen is generally introduced in gaseous form as molecular or elemental hydrogen. Preferably, molecular hydrogen is introduced. The hydrogen can also be diluted with a carrier gas, for example in a ratio of hydrogen to carrier gas of from 1:1 to 1:5000 volume percent or more. Suitable carrier gases are gases such as nitrogen, air, argon, helium and/or carbon dioxide or a mixture of these gases. Preference is given to using nitrogen, carbon dioxide and/or argon, in particular nitrogen. In most cases, however, the process is carried out without using a carrier gas.

Expediently, the hydrogen is passed upon introduction such that it comes into contact as completely as possible with the precious metal.

The hydrogen is preferably passed here in such a way or introduced in such a way that the finest possible gas bubbles are formed. These gas bubbles are mixed as intensively as possible with the precious metal and subsequently or simultaneously mixed with the polymer solution or dispersion.

Measures suitable for this purpose are known to the person skilled in the art.

If the process according to the invention is carried out in the presence of nonprecious metal, then preferably a liquid such as solvent or liquefied gas is used which is water or comprises water. Should insufficient water be already present, then the required amount of water is added. “Required amount” is to be understood as meaning the amount which is required to ensure as complete as possible a reaction of the added amount of nonprecious metal. The person skilled in the art can directly calculate this required amount.

Should essentially water-free liquid, for example essentially water-free organic solvent or liquefied gas, be used, then the process according to the invention, however, preferably takes place with a precious metal. The presence of water is then not necessary. However, the presence of water is tolerable for the treatment.

In one particularly preferred embodiment, the polymer is treated with nonprecious metal in a liquid comprising water or consisting of water without the introduction of gaseous hydrogen.

It is particularly advantageous here that the nonprecious metal is inexpensive, can be handled easily and with minimum complexity in terms of safety, even on a production scale, and also the complete disappearance of the nonprecious metal as a result of dissolution with the formation of nascent hydrogen and metal salt, where the metal salt which is formed is physiologically acceptable and can remain in the product.

Should the pH of the liquid change as a result of the dissolution of the nonprecious metal and the formation of the metal salt, then it can be corrected through suitable acids, bases or buffer materials. Of suitability in principle for this are all substances known to the person skilled in the art.

Typical acids are, for example, hydrochloric acid, sulfuric acid, sulfurous acid, phosphoric acid and acidic salts thereof, such as hydrogen sulfate, hydrogen phosphate, dihydrogen phosphate, organic acids such as formic acid, acetic acid, malonic acid, lactic acid, oxalic acid or citric acid, and acidic salts thereof. Typical bases are, for example, sodium hydroxide, potassium hydroxide, calcium hydroxide, ammonium hydroxide and aqueous solutions thereof, mono-, di- and trialkylamines or -alkanolamines having C1- to C4-alkyl or having C1- to C4-alkanol, such as diethylamine, triethylamine and diethanolamine or triethanolamine.

Acids or bases may also be mixtures of two or more acids or bases, respectively. Typical pH buffers are, for example, mixtures of different phosphate salts and of different hydrogen carbonates with one another or among one another.

In a further particularly preferred embodiment, for the treatment of polymer, precious metal is used as shaped material with the introduction of molecular hydrogen and by bringing the hydrogen into contact with the precious metal and the polymer.

It is particularly advantageous here that virtually no metal at all passes into the polymer and remains there. Only a very small amount of metal due to mechanical abrasion from the shaped material can pass into the polymer. However, these amounts are usually less than 1 ppm. The precious metals used are also physiologically acceptable, in particular in these low amounts.

Very particular preference is given to the embodiment using nonprecious metals.

The metal is generally used in amounts of from 0.005 to 1% by weight, based on the amount of polymer, preferably from 0.01 to 0.5% by weight and particularly preferably from 0.03 to 0.20% by weight.

The amount of precious metal used for the treatment according to the invention is usually selected here such that—should the metal remain in the polymer—at most 5 ppm remain in the polymer, based on the polymer solids content, per metal used.

If a larger amount of precious metal is required or desired for the treatment or if a larger amount is added, then the metal content can be reduced again to the desired amounts by suitable methods and methods known to the person skilled in the art following the treatment.

Ion exchangers, for example, are suitable for a subsequent removal of metal ions.

If precious metal is therefore used for the treatment according to the invention, then the amount used is generally selected such that, following the treatment, at most 5 ppm, preferably at most 2 ppm and especially preferably less than 1 ppm, of this metal remain in the product without subsequent use of a metal removal method (ppm based on weight).

If more than one precious metal is employed, the above limit values apply individually to each type of metal.

Preferably, the total content of all of the precious metals used for the process and remaining in the polymer, based on the polymer solids content, is less than 10 ppm, preferably less than 5 ppm, particularly preferably less than 2 ppm and especially preferably less than 1 ppm.

Particular preference is given to using amounts of precious metals such that in the polymer following the treatment only amounts of metal remain such that the total ash content (also called residue on ignition) satisfies the particular requirements according to the relevant regulations.

Such relevant regulations governing the maximum metal and ash contents of the polymers to be treated are known to the skilled person in the respective field of application. Regulations relevant in the pharmaceutical sector are, for example, the European Pharmacopeia (Ph.Eur.), the Japanese Pharmacopeia for excipients (JPE), the US-American Pharmacopeia (USP) and the Germany Pharmacopeia (DAB) in their most current valid version in each case. Regulations relevant to the food sector are, for example, those issued by the FDA (Food and Drug Administration) in the USA or those arising from German food legislation.

If nonprecious metal is used for the process according to the invention for the treatment of polymer in liquid, then the amount used is preferably selected such that, following the treatment, not more than 2000 ppm, preferably not more than 1000 ppm and in particular not more than 500 ppm, of this metal remain in the product. The nonprecious metal will here usually remain in the polymer as metal salt following the treatment. However, if the nonprecious metal used is non-critical for the intended field of application or, in particular, is a metal that is harmless to humans, animals or plants (eg: sodium, magnesium, calcium, zinc), the amounts used shall be such that the metal content after treatment, based on the polymer solids, does not exceed the maximum value given in the relevant regulations, which are known to the skilled person in the respective field. This applies likewise for maximum limit values of other substances to be further observed according to the relevant regulations, such as, for example, maximum total ash contents.

If more than one nonprecious metal is employed the above limit values apply individually to each type of metal, and —if the relevant regulations demand it—also for the respective total ingredient amounts of the particular category such as metals or ash.

The person skilled in the art is aware which particular regulation must be deemed relevant for the application and can therefore directly establish what amount of metal depending on the type of metal and what total amount of metal, and also what total ash content and which other maximum limit values apply.

In the specific case of exercising the present invention, the person skilled in the art will usually ascertain, by reference to the relevant regulations, firstly the permissible total content of individual metal, of total metal content and/or total ash content for the polymer in question and then calculate the permissible amount of metal addition. Similarly, he will determine by generally known methods the actual total ash content, the total metal content and the content of individual metal in the polymer without the treatment. From the difference between the permissible contents without the treatment and the permissible contents according to the relevant regulations, the person skilled in the art can directly calculate the permissible addition amount per metal for this polymer. Usually, for the addition amount of metal he will establish a safety reduction of about 5 to 10% based on the permissible addition amount of metal in order to be able to take into consideration fluctuations in production. It is easy for a person skilled in the field to determine the normal variation in the chosen process and then set an appropriate safety margin for the addition amount.

In addition, in his consideration, the person skilled in the art will take into account, and if appropriate determine analytically, those amounts of metal which are formed by, for example, abrasion of precious metal. This can be caused for example on account of the selected shape of the metal, such as a shaped material, and also on account of the arrangement for example of this shaped material in the container in which the process is carried out. Whether abrasion arises can be established very easily by the person skilled in the art by means of analysis.

For his calculation, he will also assume that the added amount of nonprecious metal is dissolved completely to give metal ions.

The process according to the invention is generally carried out such that the solution or dispersion obtained after the polymerization or the solution or dispersion prepared from solid polymer is brought into contact with metal at elevated temperatures. This treatment can take place at 10 to 100° C., preferably at 40 to 90° C.

Temperatures below zero and above 100° C. are in principle also possible for the treatment: however, relatively low temperatures generally lead to higher costs for cooling, and relatively high temperatures generally result in higher costs for the heating, and also possible thermal damage to the polymer for example as a result of accelerated oxidation.

The treatment period is governed primarily by the amount to be treated and can be in the region of minutes or hours. The treatment time is usually in the range from 1 min up to 4 hours, preferably 10 min up to 1 hour.

The treatment can take place at pH values from 3 to 11. The treatment of the water-soluble or water-dispersible polymers can take place either in an acidic medium or in an alkaline medium. If, for example, after the polymerization an acidic hydrolysis takes place to reduce the residual monomer content, the treatment can also be carried out at acidic pH values.

The treatment can also take place in a neutral to alkaline medium. This is advantageous, for example, in the case of the treatment of water-insolubly crosslinked polymers, such as polyvinylpyrrolidone popcorn polymers since their polymerization is usually carried out in the slightly to moderately alkaline range and consequently no pH reduction is then required for the treatment.

The person skilled in the art is aware of the pH ranges suitable in each case for safe, nondestructive handling of the polymers in question.

According to the invention, following the treatment with elemental metal in a liquid, additionally reducing agent and/or antioxidant can be added to the low-peroxide polymer.

Antioxidant may be an individual compound or a mixture of two or more antioxidants. Such compounds are also referred to as free-radical scavengers and, within the context of this invention, are comprised by the term “antioxidant”.

“Reducing agent” may be an individual compound or a mixture of two or more reducing agents.

If reducing agent and antioxidant are used, then this can take place in parallel or sequentially. Preferably, the addition takes place sequentially. Especially preferably, firstly the addition of reducing agent takes place and then the addition of antioxidant.

Reducing agent and/or antioxidant may be added to the polymer present in liquid in solid form, dispersed or dissolved in a suitable solvent. A preferred solvent is the same as the liquid used in each case for the process.

The addition of reducing agent and/or antioxidant generally takes place at temperatures from 10 to 100° C., preferably 15 to 80° C. and particularly preferably 20 to 60° C. The preferred pH range for the addition is 3 to 11, preferably 6 to 10, particularly preferably 7 to 9.

Preferably, the reducing agent is added, then a waiting time generally follows, expediently at elevated temperature. Within this waiting time, the polymer solution or dispersion is kept at elevated temperature from 20 to 90° C., preferably at 40 to 80° C., and preferably thoroughly mixed. This waiting time usually lasts a few minutes up to several hours, preferably from at least 5, particularly preferably at least 30 and especially preferably at least 60 minutes, but usually not longer than 4, preferably not longer than 2 hours.

Then, antioxidant is added, optionally followed by a further waiting time, preferably likewise with thorough mixing. This further waiting time after adding antioxidant usually lasts a few minutes up to several hours, preferably at least 5, particularly preferably at least 15 and especially preferably at least 30 minutes, but is usually not more than 2 and preferably not more than 1 hour.

As the volume of polymer solution or dispersion increases, so too does the waiting time period.

Suitable reducing agents are, for example, sulfur dioxide, sulfurous acid or sulfites, in particular alkali metal or alkaline earth metal sulfites, for example potassium sulfite, potassium hydrogen sulfite, lithium sulfite, lithium hydrogen sulfite, sodium sulfite or sodium hydrogen sulfite, preference being given to sodium sulfite or sodium hydrogen sulfite and also sulfur dioxide. Sulfur dioxide is especially preferably in the form of an aqueous solution.

Even small amounts of reducing agent and/or antioxidant suffice for the present invention.

The reducing agents can be used, for example, in amounts of from 0.005 to 1% by weight, based on solid polymer, preferably 0.01 to 0.5% by weight and particularly preferably 0.03 to 0.20% by weight.

Antioxidant can in each case be used in amounts of, for example, 0.01 to 1% by weight, based on solid polymer, preferably 0.03 to 0.5% by weight, particularly preferably 0.05 to 0.25% by weight.

Suitable antioxidant which can be used according to the invention is selected, for example, from:

phenolic antioxidants, such as sodium salicylate, the potassium salt of methylbenzotriazole, 2-mercaptobenzimidazole, 2,4-dihydroxybenzophenone, 2,6-di-t-butyl-p-cresol, butylated hydroxyanisole, 2,6-di-t-butyl-4-methylphenol, 2,6-di-t-butyl-4-ethylphenol, stearyl β-(3,5-di-t-butyl-4-hydroxyphenyl)propionate, propyl-3,4,5-trihydroxybenzoate, hydroquinone, and catechol;
bisphenolic antioxidants, such as 2,2′-methylenebis(4-methyl-6-t-butylphenol), 2,2-methylenebis(4-ethyl-6-t-butylphenol), 4,4′-thiobis(3-methyl-6-t-butylphenol), 4,4′-butylidenebis(3-methyl-6-t-butylphenol), 3,9-bis{1,1-dimethyl-2-[β-3-t-butyl-4-hydroxy-5-methylphenyl)propionyloxy]ethyl}-2,4,8,10-tetraoxaspiro[5,5]undecane, and also 4,4′-(2,3-dimethyltetramethylene)dipyrocatechol;
high molecular weight phenolic antioxidants, such as 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis[methylene-3-(3′,5′-di-t-butyl-4′-butylphenyl)propionate]methane, bis[3,3′-bis(4′-hydroxy-3′-t-butanoic acid]glycol ester, 1,3,5-tris(3′,5′-di-t-butyl-4′-hydroxybenzyl)-s-triazine-2,4,6-(1H,3H,5H)trione, and tocopherol;
sulfur-containing antioxidants, such as dilauryl 3,3′-thiodipropionate, dimyristyl 3,3′-thiodipropionate, distearyl 3,3′-thiodipropionate, 2-mercaptobenzimidazole, tetrakismethylene-3-(laurylthio)propionate methane, and stearylthiopropylamide; phosphorous-containing antioxidants, such as triphenyl phosphite, diphenyl isodecylphosphite, phenyl diisodecylphosphite, 4,4′-butylidenebis(3-methyl-6-t-butylphenylditridecyl) phosphite, cyclic neopentanetetraylbis(octadecyl) phosphite, tris(nonylphenyl) phosphite, tris(mono- and/or dinonylphenyl) phosphite, diisodecylpentaerythritol diphosphite, 9,10-dihydro-9-oxa-10-phosphaphenantrene 10-oxide, 10-(3,5-di-t-butyl)-4-hydroxybenzyl)-9,10-dihydro-9-oxa-10-phosphaphenantrene 10-oxide, 10-decyloxy-9,10-dihydro-9-oxa-10-phosphaphenantrene, tris(2,4-di-t-butylphenyl) phosphite, cyclic neopentanetetraylbis(2,4-di-t-butylphenyl) phosphite, cyclic neopentanetetraylbis(2,6-di-t-butyl-4-methylphenyl) phosphite; 2,2-methylenebis(4,6-di-t-butylphenyl)octyl phosphite, distearyl pentaerythritol diphosphite, di(2,4-di-t-butylphenyl) phosphite, and tetrakis(2,4-di-t-butylphenyl)-4,4-biphenylene phosphonite;
antioxidants comprising alcohol groups, such as erythorbic acid, sodium erythorbate, and isopropyl citrate;
antioxidants comprising amine groups, such as methylated diphenylamine, ethylated diphenylamine, butylated diphenylamine, octylated diphenylamine, laurylated diphenylamine, N,N′-di-sec-butyl-p-phenylenediamine, and also N,N′-diphenyl-p-phenylenediamine;
antioxidants with hindered amino groups, such as 4-benzyloxy-2,2,6,6-tetramethylpiperidine, bis(2,2,6,6-tetramethyl-4-piperidinyl) sebacate, bis(1-octyloxy-2,2,6,6-tetramethylpiperidinyl) sebacate, bis(1,2,2,6,6-pentamethyl-4-piperidinyl) sebacate, dimethyl succinate 1-(2-hydroxyethyl)-4-hydroxy-2,2,6,6-tetramethylpiperidine or condensation products thereof, and also 8-acetyl-3-dodecyl-7,7,9,9-tetramethyl-1,3,8-triazaspiro[4.5]decane-2,4-dione.

Suitable antioxidants are in particular: ascorbic acid, nordihydroguaiaretic acid, ethoxyquin, bisabolol, ascorbyl palmitate or BHT (“butylhydroxytoluene”: 2,6-di-tertiary-butyl-4-methylphenol) or mixtures thereof.

It is also possible to use ammonium, alkali metal, alkaline earth metal salts of ascorbic acid, such as, for example, ammonium ascorbate, sodium ascorbate or magnesium ascorbate or mixtures thereof. Also suitable are esters of ascorbic acid with inorganic or organic acids, such as ascorbyl carbonate, ascorbyl phosphate, ascorbyl sulfate, ascorbyl stearate or ascorbyl palmitate, and also ammonium, alkali metal, alkaline earth metal salts thereof, for example sodium ascorbyl phosphate or sodium ascorbyl palmitate. Mixtures of these compounds can likewise be used.

Preference is given to using sodium sulfite, sodium hydrogen sulfite and/or sulfur dioxide in aqueous solution as reducing agent and/or ascorbic acid as antioxidant. The use of sulfur dioxide and ascorbic acid is particularly preferred. Of particular preference in the treatment of water-insolubly crosslinked polymer is only the addition of antioxidant, in particular of ascorbic acid, without the addition of reducing agent.

The treatment of the polymer with metal and optionally the addition of reducing agent and optionally the addition of antioxidant takes place in each case preferably with thorough mixing such as stirring. Mixing by blowing in a gas, for example a protective gas, or by circulating by pumping with and without static mixers is also possible, as are combinations of two or more methods for thorough mixing.

Usually, the process according to the invention for the treatment of polymer is carried out in liquid at atmospheric pressure, although it may also be advisable to work at a superatmospheric pressure up to 1.6 MPa.

The superatmospheric pressure can be achieved for example by injecting an inert gas such as nitrogen or by increasing the temperature of a closed container.

It may also be advisable to work under a protective-gas atmosphere using inert gases such as, for example, nitrogen, helium, argon and/or carbon dioxide or mixtures thereof. A suitable protective gas (synonymous with “inert gas”) is preferably nitrogen. Preferably, protective gas is used such that the oxygen content in the system is less than 50 000 ppm, in particular less than 20 000 ppm and very particularly preferably less than 10 000 ppm. Usually, an oxygen content of less than 5000 ppm, preferably less than 2000 ppm or even less than 1000 ppm oxygen content is regularly achieved (ppm: based on the gas volume; 5000 ppm correspond to 0.5% by volume).

In one particularly preferred embodiment, the treatment of the polymer takes place under a nitrogen protective-gas atmosphere with less than 5000 ppm of oxygen.

The polymer treated in this way in liquid can—if desired—then be converted to a solid polymer, for example pourable powder, by drying. Methods for drying are known to the person skilled in the art.

The drying can take place, for example, by spray-drying, drum-drying or another warm-air or contact-heat drying. Drying by means of vacuum-drying or freeze-drying is also possible. All other methods for drying are in principle likewise suitable. Drying methods with spraying such as spray-drying and by means of contact surfaces such as drum-drying are preferred drying methods.

However, it is also possible to dispense with the drying, for example if polymer solutions or dispersions are desired.

Drying under protective gas is possible and further improves the result of the treatment. It is a particular advantage of the present invention that even upon dispensing with a protective gas during drying, the polymer has improved long-term stability.

Solid polymer is usually packaged in suitable packaging materials directly after the drying. In principle, it is possible to use all packaging materials which are suitable and permissible for pharmaceutical, food or cosmetics applications or for the application desired in each case.

Of course materials which are of low permeability, or are virtually impermeable, for oxygen are advantageous. By avoiding or minimizing polymer contact with oxygen during storage, the further oxidation of the polymer is again further reduced. In addition to the treatment with metal and optionally subsequent addition of reducing agent and/or antioxidant, the packaging of the polymer can of course also additionally take place with nitrogen or noble-gas gasing or by means of vacuum application. Naturally, the sole use of inert packaging materials, such as in particular of materials and films which have little or virtually no permeability for oxygen also further improves the stability of the polymer against oxidation and peroxide build-up. Packaging under protective gas in such inert packaging materials likewise naturally further improves the result.

Surprisingly, however, it has been found that the use of these methods is not necessary for the present invention. Rather, a low-peroxide polymer prepared by the process according to the invention has excellent long-term stabilization against the increase in peroxide content upon storage, even if the packaging materials are oxygen-permeable, the packaging is not tight against the entry of oxygen, and/or the polymer is located in an atmosphere with high oxygen content of more than 2% by volume ranging to normal air and its known oxygen content. This indicates to a particular extent the protective function of the stabilization of polymer as a result of the process according to the invention for the treatment compared with the methods for stabilization known hitherto. In particular, stability upon thermal stress and stability in oxygen-containing medium are considerably improved.

One advantage of the polymers according to the invention is their stability, i.e. the fact that the properties such as peroxide content, molar mass, color and odor which they have following preparation barely change over the course of time. In particular, the determination of the peroxide content can serve as a measure of the grade of the polymer. In addition, molar mass, K value, viscosity of solutions, odor and/or color can be used.

The peroxide content in the polymer is determined here by means of iodometry, by means of titanyl reagent or by means of cerium reagent. The methods are known to the person skilled in the art, for example from Ph.Eur.6.

Here, the polymers according to the invention have, two days after treatment, a peroxide content of up to 50 ppm (weight), preferably up to 20 and especially preferably up to 10 ppm or less, and/or have, following storage at room temperature, a peroxide content, determined at any desired time within 3 months after the date of manufacture, which is not higher than 100 ppm, preferably not higher than 50 ppm, particularly preferably not higher than 20 ppm and especially preferably not higher than 5 ppm.

The K value (Fikentscher K value; see for example Bühler, “Polyvinylpyrrolidone—Excipient for Pharmaceuticals”, Springer, 2005, page 40 to 41) is a measure of the solution viscosity under defined conditions. Consequently, it is a direct measure of the molar mass. If the molar mass changes, for example as a result of oxidative processes, this leads to a build-up in molar mass (leads to the K value increase) or to molar mass reduction (leads to the K value decrease) and thus to a change in the K value. The formation and disintegration of peroxides in the polymer is one such oxidative process.

Consequently, the process according to the invention also achieves a stability of the K value and thus of the molar mass upon storage. Since the molar mass and solution viscosity (as characterized by the K value) are directly related, the solution viscosity of the treated polymer does not—or does so only to a very small extent—differ from that of the untreated polymer.

Following storage at room temperature, the K value, determined at any desired time within 3 months after the date of manufacture, exhibits a deviation of usually less than 10%, preferably less than 5% and in particular less than 2%, based on the starting K value of the sample to be measured, which is determined 2 days after using the process according to the invention for the treatment.

The color of the polymer is important depending on the application. The color can be determined, for example, by means of spectroscopic methods and be quoted for example as Hazen color number or iodine color number.

As a result of the oxidative processes during the formation and disintegration of peroxides within the polymer, color-imparting components are also formed; these alter, usually impair, the color of the polymer, i.e. depending on the color scale, usually have higher color values than previously.

The process according to the invention drastically reduces the peroxide build-up or even prevents it and thus also the breakdown. Consequently, changes in the color of the polymer are reduced or even completely prevented.

Consequently, the process according to the invention also achieves a stability of the color of the polymer upon storage.

Following storage at room temperature, the Hazen color (also called “Hazen color number” or “cobalt-platinum color number”), determined at any desired time within 3 months after the date of manufacture, exhibits a color impairment (color number increase) of usually less than 10%, preferably less than 5%, especially less than 3% and very especially 1% or less, based on the starting color value, which is determined 2 days after the treatment according to the invention. Determination of the Hazen color number is known to the person skilled in the art.

The odor of the polymer is likewise important depending on the application. The polymer should not have a bad odor. Similarly, no bad odor should arise upon storage. The odor of the polymer can be determined for example by headspace GC methods using odor profiles or by olfactory means, for example using the human nose (for example of trained personnel, such as perfumers). As a result of oxidative processes in the course of the peroxide formation and decomposition, besides color-imparting substances, odor-forming substances also arise, which lead for example to a “musty” odor.

As a result of using the process according to the invention for the treatment of polymer with metal in liquid, this change to undesired odors, determined at any desired time within 3 months after the date of manufacture, is also drastically reduced or even completely avoided.

The “date of manufacture” refers to the date which is usually stated by the manufacturers of polymers on the packaging of the polymer, normally on the label. This is either the actual production date, i.e. the date on which the polymerization and all of the subsequent steps up to the saleable form were completed, or the date of packaging of the saleable form in the sales packaging. These dates are normally only one to at most two days apart. Within the context of the present invention, date of manufacture is therefore understood as meaning the latest date assigned to the preparation or packaging of the polymer.

The polymers obtained by the process according to the invention are particularly advantageously suitable for use in pharmaceutical or cosmetic preparations or for use in food and semi-luxury food technology. Allergic reactions or other incompatibilities as can arise as a result of heavy metals or enzymes are completely avoided.

The polymers can also advantageously be used for example in conjunction with active ingredients in the field of agriculture or veterinary medicine.

The polymers have likewise proven advantageous for use in technology, for example medical technology such as dialysis membranes or other substances or apparatuses which come into contact with the body or body liquids or pass or are introduced into the body. Likewise advantageous is the use in applications which are critical as regards color and/or odor, such as hair cosmetics, adhesives or surface coating.

Likewise comprised by the invention are drugs which comprise polymer obtainable by the process according to the invention or polymer which, two days after the treatment, has a peroxide content of up to 50 ppm (weight), preferably up to 20 and especially preferably of up to 10 ppm, and/or after storage at room temperature, a peroxide content, determined at any desired time within 3 months after the date of manufacture, which is not higher than 100 ppm, preferably not higher than 50 ppm, especially preferably not higher than 20 ppm and especially preferably not higher than 5 ppm. Besides polymer and active ingredient, the drug can also comprise further customary excipients such as binders, disintegration promoters, tablet disintegrants, surfactants, taste masking agents and/or sweeteners.

Suitable active ingredients are in principle all known active ingredients. Possible active ingredients are disclosed, for example, in US 2008-0181962 in paragraph [0071], from the seventh-last line to the end of this paragraph, to which reference is hereby expressly made.

In principle, all fields of application are possible, for example those specified in US 2001-0010825 on page 1, paragraph [0029], last line, to paragraph [0074] end, and the exemplary examples of active ingredients specified therein, to which reference is likewise expressly made here.

The following examples illustrate the invention in an exemplary and nonlimiting manner.

### EXAMPLES

The peroxide content was determined for all samples by the iodometric method. The numbers stated refer to the ppm values (=mg of peroxide/kg of polymer), calculated as hydrogen peroxide.

The method is described for example in the European Pharmacopeia edition 6 (Ph.Eur. 6). However, every other possible determination of the peroxide content is likewise conceivable, for example titrimetric determination by means of cerium or titrimetric determination by means of titanyl sulfate. All three specified methods produce identical results within the framework of measurement accuracy and can thus be used interchangeably.

Measurement parameter: peroxide content (expressed in mg of H2O2/kg) of polyvinylpyrrolidone.

Measurement principle: the peroxides are reduced with potassium iodide and the iodine which is formed in the process is detected photometrically at 500 nm. Working range w(H2O2): 6 to 500 mg/kg (6 to 500 ppm)

Detection: UV/VIS spectrometer, for example model Lambda 25 from Perkin Elmer

Example of sample preparation: Ca.1.5-2 g of sample were weighed in accurately to 0.1 mg and dissolved in about 20 ml of a 1:1 mixture of trichloromethane and glacial acetic acid. For more rapid dissolution, the vessel was placed in an ultrasound bath for about 5-10 min. Then, 0.5 ml of saturated KI solution was added, the solution was then topped up to 25 ml with trichloromethane/glacial acetic acid and thoroughly mixed. For the reagent blank value, 24.5 ml of the 1:1 mixture of trichloromethane and glacial acetic acid were admixed with 0.5 ml of the saturated KI solution. After a waiting time of 5 min, measured from the addition of the saturated KI solution, measurement was carried out against the entrained reagent blank value. The measurement was carried out at the edge of the band of the iodine absorption (with a maximum at 359 nm), because in this region no disturbances arise as a result of the matrix.

Measurement parameters: wavelength: 500 nm; gap: 2 nm; layer thickness of the solution: 5 cm; measurement temperature: 20 to 25° C. Measurement accuracy: ˜plus/minus 8%.

Calculation (for other layer thicknesses and volumes etc. analogous thereto)

$$w ( {H}_{2} {O}_{2} ) = \frac{{E}_{5 cm} - b}{a} \times \frac{V}{m}$$

with w(H₂O₂)=Mass fraction of peroxide in mg/kg (=in ppm)
   E_{5cm}=Extinction at a layer thickness of 5 cm
   b=Ordinate intercept from the calibration
   a=Increase in the regression lines from the calibration
   m=Initial weight of sample in g
   V=Volume of the sample solution (here: 25 ml)

### Calibration:

Six calibration solutions were prepared as follows: approximately 300 mg of 30.2% hydrogen peroxide solution was weighed into a 100 ml measuring flask and topped up to 100 ml with a 1:1 mixture of trichloromethane and glacial acetic acid. Six volumes of stock solution (0.01 ml, 0.02 ml, 0.05 ml, 0.1 ml, 0.2 ml and 0.5 ml) were taken and to each was added approx. 20 m of trichloromethane/glacial acetic acid (1:1). Next, 0.5 ml of saturated K1 solution was added and the volume made up to 25 ml with trichloromethane/glacial acetic acid. This gave six solutions which comprised about 0.3 to 18 mg of hydrogen peroxide per liter. 5 minutes after the addition of the KI reagent, the solutions were measured as described above against an entrained reagent blank value. From the extinctions obtained for the calibration solutions, a regression line of the form E_{5cm}=a*β+b was calculated, where E_{5cm} is the extinction at a layer thickness of 5 cm and β (beta) is the mass concentration of hydrogen peroxide in the calibration solutions (stated in mg/l). The calculation here produced the function E_{5cm}=0.038911+0.0013 with a correlation coefficient of R²=0.9998.

### Polymers Used:

PVP: water-soluble N-vinylpyrrolidone homopolymer; Polymer 1: PVP with K value 30;
Polymer 2: PVP with K value 90
Copovidone: copolymer of N-vinylpyrrolidone and vinyl acetate in the weight ratio 60:40, K value 28 (=Polymer 3)
Crospovidone: crosslinked water-insoluble polyvinylpyrrolidone (PVPP, “Popcorn PVP”); Polymer 4: Kollidon® CL, BASF SE; average particle size 110 μm; Polymer 5: Kollidon® CL-F, BASF SE; average particle size 30 μm
Crosslinked water-insoluble poly(vinylpyrrolidone-co-vinylimidazole) (“Popcorn” Polymer), weight ratio of VP:VI=1:9; Polymer 6: Divergan® HM, BASF SE.
Copolymer of vinylpyrrolidone and vinylimidazole in the weight ratio 1:1, K value 32 (Polymer 7)
Copolymer of vinylpyrrolidone and vinylcaprolactam in the weight ratio 1:1, K value 65 (Polymer 8)
Graft copolymer of PEG, vinylcaprolactam and vinyl acetate in the weight ratio
PEG:VCap:VAc=15:55:30, molar mass 25 000 g/mol Mw (Polymer 9)

For the comparison, the untreated polymers were used in solution or suspension, as were obtained from the polymerization.

Percentages are % by weight. “ppm” data are based on the weight (1 ppm=1 mg/kg). Data in percent by weight and ppm refer in each case to solid polymer (the polymer solids content), i.e. the amount of polymer which is present in a solution or suspension.

In all of the examples, the treatment with metal was carried out under nitrogen (technical grade) with an oxygen content of from about 1 to 5% by volume. Further work-up such as drying and storage was carried out under air. The PE bottles used were screw-top bottles customary for powders.

### Examples 1 to 6

An aqueous polymer solution was admixed at 50° C. with 0.1% by weight of calcium granules (“Calcium granules, redistilled, -6 mesh, 99.5% (metals basis)” from Alfa Aesar GmbH & Co KG, Karlsruhe. Article number 875. Lot# 108P15. 6 mesh correspond to a particle size up to max. 3.4 mm) based on polymer and the solution was stirred for one hour. For examples 2, 4 and 6, the solution was then additionally cooled to 40° C. and admixed with 0.1% by weight of ascorbic acid based on polymer and stirred for 30 minutes.

All of the polymer solutions were then spray-dried. The pulverulent polymer was then bottled in PE bottles. The peroxide content was determined two days after treatment and also after storage for three and six months.

The results are listed in table 1 below.

Examples 1 and 2: 30% strength aqueous solution of Polymer 1
Examples 3 and 4: 20% strength aqueous solution of Polymer 2
Examples 5 and 6: 40% strength aqueous solution of Polymer 3

TABLE 1
Examples 1 to 6, soluble PVP and VP copolymers

| | | | | Peroxides [ppm]* . . . | | |
|---|---|---|---|---|---|---|
| | | | Antioxidant: | after treatment | | |
| | Poly- | Metal, [% | ascorbic acid | 2 | 3 | 6 |
| Example | mer | by wt.]* | [% by wt.]* | days | months | months |
| Comparison | 1 | — | — | 57 | 174 | |
| 1 | 1 | Ca, 0.05 | — | 30 | 123 | |
| 2 | 1 | Ca, 0.05 | 0.10 | 34 | 31 | |
| Comparison | 2 | — | — | 146 | 152 | 143 |
| 3 | 2 | Ca, 0.05 | — | 35 | 27 | 42 |
| 4 | 2 | Ca, 0.05 | 0.1 | 24 | <20 | <20 |
| Comparison | 3 | — | — | <20 | 53 | 89 |
| 5 | 3 | Ca, 0.05 | — | <20 | 29 | 47 |
| 6 | 3 | Ca, 0.05 | 0.10 | <20 | <20 | <20 |

*based on solid polymer

### Example 7

An 8.5% strength suspension of Polymer 4 in water was adjusted to pH 8 with ammonia water or adjusted to pH 4 with formic acid, then admixed at 50° C. with different amounts of calcium, magnesium or zinc powder, and the suspension was stirred for one hour. The suspension was then cooled to 40° C. and admixed with 0.1% by weight of ascorbic acid, based on polymer. The polymer was then filtered off and dried in the vacuum drying cabinet under nitrogen at 60° C. for 16 hours. The pulverulent polymer was then bottled in PE bottles. The peroxide content was determined directly after treatment and also after storage for 3 months. The type and amount (based on polymer solids content) of the metal used and also the results are listed in table 2 below.

TABLE 2
Polymer 4

| | Amount | | | | |
|---|---|---|---|---|---|
| | of metal | | Antioxidant: | Peroxides [ppm]* . . . | |
| | [% by | | ascorbic acid | after treatment | |
| Metal | wt.]* | pH | [% by wt.]* | 2 days | 3 months |
| Comparison | — | — | — | 167 | 266 |
| Ca | 0.010 | 8 | 0.10 | <20 | 32 |
| Ca | 0.010 | 4 | 0.10 | <20 | 37 |
| Mg | 0.010 | 8 | 0.10 | 23 | 68 |
| Mg | 0.010 | 4 | 0.10 | 38 | 72 |
| Zn | 0.010 | 8 | 0.10 | 30 | 54 |
| Zn | 0.010 | 4 | 0.10 | 40 | 63 |
| Ca | 0.025 | 8 | 0.10 | <20 | 24 |
| Ca | 0.025 | 4 | 0.10 | <20 | 31 |
| Mg | 0.025 | 8 | 0.10 | <20 | 49 |
| Mg | 0.025 | 4 | 0.10 | <20 | 53 |
| Zn | 0.025 | 8 | 0.10 | <20 | 51 |
| Zn | 0.025 | 4 | 0.10 | <20 | 46 |
| Ca | 0.050 | 8 | 0.10 | <20 | 25 |
| Ca | 0.050 | 4 | 0.10 | <20 | 25 |
| Mg | 0.050 | 8 | 0.10 | <20 | 52 |
| Mg | 0.050 | 4 | 0.10 | <20 | 55 |
| Zn | 0.050 | 8 | 0.10 | <20 | 41 |
| Zn | 0.050 | 4 | 0.10 | <20 | 48 |

*based on solid polymer

### Example 8

An 8.5% strength suspension of the polymer in water was admixed at 50° C. with different amounts of calcium granules and the solution was stirred for one hour. Some samples were additionally also admixed with 0.1% by weight of ascorbic acid and/or 0.1% sulfur dioxide (in the form of a 6% strength solution of sulfur dioxide in water), based on polymer. The polymer was then filtered off and dried in a vacuum drying cabinet under nitrogen at 60° C. for 16 hours. The pulverulent polymer was then bottled in PE bottles. The peroxide content was determined two days after treatment and also after storage for three months. The amount of calcium granules used (based on polymer solids content) and the results are listed in table 3 below.

TABLE 3
Polymer 4 and Polymer 5

| | | Amount | | SO₂ | Peroxide content | |
|---|---|---|---|---|---|---|
| | | of metal | Antioxidant: | [% | [ppm]* . . . after | |
| | | [% by | ascorbic acid | by | treatment | |
| Polymer: | Metal | wt.]* | [% by wt.]* | wt.]* | 2 days | 3 months |
| 5 | Com- | — | — | — | 164 | 221 |
| | parison | | | | | |
| 5 | Ca | 0.03 | — | — | <20 | 66 |
| 5 | Ca | 0.03 | 0.1 | — | <20 | 45 |
| 5 | Ca | 0.03 | 0.1 | 0.1 | 30 | 44 |
| 5 | Ca | 0.05 | — | — | <20 | 66 |
| 5 | Ca | 0.05 | 0.1 | — | <20 | 42 |
| 5 | Ca | 0.05 | 0.1 | 0.1 | <20 | 39 |
| 5 | Ca | 0.05 | — | — | <20 | 90 |
| 5 | Ca | 0.05 | 0.1 | — | <20 | 75 |
| 5 | Ca | 0.05 | 0.1 | 0.1 | 60 | 76 |
| 4 | Com- | — | — | — | 298 | 360 |
| | parison | | | | | |
| 4 | Ca | 0.03 | — | — | 32 | 62 |
| 4 | Ca | 0.03 | 0.1 | — | 29 | 56 |
| 4 | Ca | 0.03 | 0.1 | 0.1 | <20 | 57 |
| 4 | Ca | 0.05 | — | — | <20 | 37 |
| 4 | Ca | 0.05 | 0.1 | — | <20 | 36 |
| 4 | Ca | 0.05 | 0.1 | 0.1 | <20 | 60 |
| 4 | Ca | 0.05 | — | — | <20 | 47 |
| 4 | Ca | 0.05 | 0.1 | — | 25 | 57 |
| 4 | Ca | 0.05 | 0.1 | 0.1 | <20 | 43 |

*based on solid polymer

### Example 9

An 8.5% strength or 16% strength suspension of Polymer 4 in water was admixed at 50° C. with 0.03% calcium granules (based on polymer) and the solution was stirred for one hour. Here, in one case, the total amount of calcium was added all at once, in the second case the amount of calcium was added in five portions over a period of 30 minutes. The polymer was then filtered off and dried in a vacuum drying cabinet under nitrogen at 60° C. for 16 hours. The pulverulent polymer was then bottled in PE bottles. The peroxide content was determined two days after treatment and after storage for three months. Amount of the calcium granules used (based on polymer solids content) and the results are listed in table 4 below.

TABLE 4
Polymer 4

| Polymer | | | | | | |
|---|---|---|---|---|---|---|
| solids | | Addition of | Peroxide | | | |
| content in | | metal in | [ppm]* . . . after treatment | | | |
| suspension | Metal | [number of | | 3 | 6 | 9 |
| [% by wt.] | [% by wt.]* | portions] | 2 days | months | | |
| 16 | Comparison | — | 249 | 339 | 364 | 391 |
| 8.50 | Ca, 0.03% | 1 | <20 | <20 | 24 | 32 |
| 8.50 | Ca, 0.03% | 5 | <20 | <20 | <20 | <20 |
| 16 | Ca, 0.03% | 1 | <20 | <20 | <20 | 22 |
| 16 | Ca, 0.03% | 5 | <20 | <20 | <20 | <20 |

*based on solid polymer

### Example 10

A 12% strength suspension of Polymer 6 in water was admixed at 50° C. with calcium powder and the suspension was stirred for one hour. The suspension was then cooled to 40° C. and 0.1% by weight of ascorbic acid, based on solid polymer, was added. The polymer was then filtered off and dried in the vacuum drying cabinet under nitrogen at 60° C. for 16 hours. The pulverulent polymer was then bottled in PE bottles. The peroxide content was determined two days after treatment and also after storage for three months. Type and amount (based on polymer solids content) of the metal used and the results are listed in table 5 below.

TABLE 5
Polymer 6

| | | | Peroxide [ppm]* . . . | | |
|---|---|---|---|---|---|
| | Metal | | after treatment | | |
| Example | [% by wt.]* | Metal | 2 days | 3 months | 6 months |
| Comparison A | — | — | 52 | 173 | 259 |
| 10 | 0.05% | Ca | <20 | <20 | <20 |
| Comparison B | — | — | 65 | 197 | 284 |
| 10 | 0.05% | Zn | <20 | <20 | 21 |
| Comparison C | — | — | 45 | 160 | 192 |
| 10 | 0.05% | Mg | <20 | <20 | <20 |

*based on solid polymer

### Example 11

A 12% strength suspension of Polymer 5 in water was brought into contact at 50° C. for varying amounts of time with a platinum mesh and hydrogen gas with stirring. The suspension was then cooled to 40° C. and 0.1% by weight of ascorbic acid, based on solid polymer, was added, the polymer was filtered off and dried in the vacuum drying cabinet under nitrogen at 60° C. for 16 hours. The pulverulent polymer was then bottled in PE bottles. The peroxide content was determined two days after treatment and also after storage for three and six months. The results are listed in table 6 below.

TABLE 6
Polymer 5

| | Contact | | Peroxide [ppm]** . . . | | |
|---|---|---|---|---|---|
| | time | Amount of | after treatment | | |
| Ex. | [min] | hydrogen* | 2 days | 3 months | 6 months |
| Comparison | — | — | 164 | 221 | 368 |
| 11 | 30 | 0.5 | 22 | 31 | 46 |
| 11 | 30 | 2 | <20 | <20 | 26 |
| 11 | 60 | 2 | <20 | <20 | <20 |
| 11 | 30 | 5 | <20 | <20 | <20 |
| 11 | 30 | 10 | <20 | <20 | <20 |

*Amount of hydrogen in liters per hour and liter of reaction volume;
**based on solid polymer

### Example 12

A 30% strength aqueous solution of Polymer 1 was brought into contact at 50° C. for differing amounts of time with a platinum mesh and hydrogen gas with stirring. The solution was then cooled to 40° C. and admixed with 0.1% by weight of ascorbic acid, based on solid polymer. The solution treated in this way was spray-dried. The pulverulent polymer was then bottled in PE bottles. The peroxide content was determined two days after treatment and also after storage for three and six months. The results are listed in table 7 below.

TABLE 7
Polymer 1

| | Contact | | Peroxide [ppm]** . . . | | |
|---|---|---|---|---|---|
| | time | Amount of | after treatment | | |
| Ex. | [min] | hydrogen* | 2 days | 3 months | 6 months |
| Comparison | — | — | 57 | 174 | 288 |
| 12 | 30 | 0.5 | <20 | <20 | 48 |
| 12 | 30 | 2 | <20 | <20 | <20 |
| 12 | 30 | 2 | <20 | <20 | <20 |
| 12 | 60 | 5 | <20 | <20 | <20 |
| 12 | 30 | 10 | <20 | <20 | <20 |

*Liters per hour and liter of reaction volume;
**based on solid polymer

### Examples 13 to 18

For examples 13 to 15, the procedure of example 12 was repeated with further polymers. In some experiments, after the treatment with metal and before the addition of ascorbic acid solution, a 0.1% strength sulfur dioxide solution was likewise added. The results are shown in table 8.

For examples 16 to 18, the procedure of example 2 was repeated with further polymers. In some experiments, after the treatment with metal and before the addition of ascorbic acid solution, a 0.1% strength sulfur dioxide solution was likewise added. The results are shown in table 9.

Examples 13 and 16: Polymer 7, 30% strength aqueous solution
Examples 14 and 17: Polymer 8, 20% strength aqueous solution
Examples 15 and 18: Polymer 9, 25% strength aqueous solution

TABLE 8
Examples 13 to 15

| | | | Amount | | Peroxide | | |
|---|---|---|---|---|---|---|---|
| | | Amount | of | SO₂ | [ppm]* . . . after | | |
| | Contact | of | ascorbic | [% | treatment | | |
| | time | hydro- | acid [% | by | 2 | 3 | 6 |
| Ex. | [min] | gen** | by wt.]* | wt.]* | days | months | months |
| Compar- | — | — | — | — | 121 | 246 | 354 |
| ison to 13 | | | | | | | |
| 13 | 30 | 2 | — | — | 24 | 36 | 41 |
| 13 | 30 | 2 | 0.1 | — | <20 | <20 | 26 |
| 13 | 30 | 2 | 0.1 | 0.1 | <20 | <20 | <20 |
| Compar- | — | — | — | — | 135 | 276 | 388 |
| ison to 14 | | | | | | | |
| 14 | 30 | 2 | — | — | 34 | 31 | 43 |
| 14 | 30 | 2 | 0.1 | — | <20 | <20 | <20 |
| 14 | 30 | 2 | 0.1 | 0.1 | <20 | <20 | <20 |
| Compar- | — | — | — | — | 45 | 125 | 204 |
| ison to 15 | | | | | | | |
| 15 | 30 | 2 | — | — | <20 | <20 | 31 |
| 15 | 30 | 2 | 0.1 | — | <20 | <20 | <20 |
| 15 | 30 | 2 | 0.1 | 0.1 | <20 | <20 | <20 |

*based on solid polymer;
**amount of hydrogen: 2 liters per hour and liter of reaction volume

TABLE 9
Examples 16 to 18

| | | | Amount | | | | |
|---|---|---|---|---|---|---|---|
| | | | of | | | | |
| | | Amount | ascorbic | SO₂ | Peroxide [ppm]* . . . | | |
| | | of metal | acid | [% | after treatment | | |
| | | [% by | [% by | by | 2 | 3 | 6 |
| Example | Metal | wt.]* | wt.]* | wt.]* | days | months | months |
| Comparison | — | — | — | — | 121 | 246 | 354 |
| to 16 | | | | | | | |
| 16 | Ca | 0.05 | — | — | <20 | <20 | 26 |
| 16 | Ca | 0.05 | 0.1 | — | <20 | <20 | <20 |
| 16 | Ca | 0.05 | 0.1 | 0.1 | <20 | <20 | <20 |
| Comparison | — | — | — | — | 135 | 276 | 388 |
| to 17 | | | | | | | |
| 17 | Ca | 0.05 | — | — | <20 | <20 | 21 |
| 17 | Ca | 0.05 | 0.1 | — | <20 | <20 | <20 |
| 17 | Ca | 0.05 | 0.1 | 0.1 | <20 | <20 | <20 |
| Comparison | — | — | — | — | 45 | 125 | 204 |
| to 18 | | | | | | | |
| 18 | Ca | 0.05 | — | — | <20 | <20 | <20 |
| 18 | Ca | 0.05 | 0.1 | — | <20 | <20 | <20 |
| 18 | Ca | 0.05 | 0.1 | 0.1 | <20 | <20 | <20 |

*based on solid polymer;
**amount of hydrogen: 2 liters per hour and liter of reaction volume

1-15. (canceled)

16. A process for the preparation of low-peroxide polymer comprising treating the polymer with elemental metal in the presence of a liquid.

17. The process according to claim 16, wherein the liquid comprises water or is water.

18. The process according to claim 16, wherein the metal is sodium, potassium, magnesium, calcium, zinc or an alloy or mixture comprising at least one of these metals.

19. The process according to claim 16, wherein the metal is platinum, palladium, rhodium, iridium, ruthenium, nickel, gold or an alloy or mixture comprising at least one of these metals.

20. The process according to claim 16, wherein the polymer is branched.

21. The process according to claim 16, wherein the polymer is polyamide, polyether or polyvinylamide or a mixture of these polymers.

22. The process according to claim 16, wherein the polymer is a vinyllactam polymer.

23. The process according to claim 16, wherein the polymer is a vinylpyrrolidone polymer or a vinylcaprolactam polymer.

24. The process according to claim 16, wherein the polymer is water-insolubly crosslinked polyvinylpyrrolidone (PVPP).

25. The process according to claim 16, wherein the polymer is an ethylene oxide polymer or a propylene oxide polymer.

26. A process for the preparation of low-peroxide polymer stabilized against peroxide formation, wherein, following the treatment according to claim 16, which further comprises adding a reducing agent or antioxidant or both reducing agent and antioxidant to the polymer.

27. A polymer obtainable by the process according to claim 18, wherein the polymer comprises not more than 5 ppm, based on the polymer solids content, and wherein the metal is platinum, palladium, rhodium, iridium, ruthenium, nickel, gold or an alloy or mixture comprising at least one of these metals and of each metal and not more than 1000 ppm, based on the polymer solids content, of each metal according to claim 18, and
a) has a peroxide content of less than 50 ppm, based on the polymer solids content, and the peroxide content was ascertained two days after treatment and/or
b) has a peroxide content of not more than 100 ppm, based on the polymer solids content, and the peroxide content was ascertained at a time point within up to 3 months after the date of manufacture, the peroxide content being determined by means of iodometry in accordance with Ph.Eur. 6.

28. An auxiliary or active ingredient in the field of cosmetics, pharmaceuticals, animal feed, animal health, technology, crop protection, beverage technology or food technology which comprises the polymer according to claim 27.

29. A drug comprising polymer comprises the polymer according to claim 27.

30. A drug comprising the polymer obtainable according to claim 16.
